(19) United States
(12) Patent Application Publication
(10) Pub. No.: US 2002/0105497 A1
(43) Pub. Date: Aug. 8, 2002

(54) CHART NAVIGATION USING COMPACT INPUT DEVICES

(76) Inventors: GUO JIN, SUNNYVALE, CA (US); CHARLES Yimin WU, SINGAPORE (SG)

Correspondence Address: MOTOROLA INC, 600 NORTH US HIGHWAY 45, LIBERTYVILLE, IL, 60048-5343, US

(21) Appl. No.: 09/465,579

(22) Filed: Dec. 17, 1999

(51) Int. Cl. G09G 5/08

(52) U.S. Cl. 345/157

(57) ABSTRACT

A data entry device (10) having an integral input element (12) capable of recording input movement in two dimensions (including Chinese strokes and characters, Roman letters and Arabic numerals) and delivering resultant signals to a processor (11). The processor (11) is programmed for identifying a handwriting input represented by the signals. The apparatus includes an array of switching elements (20) capable of recording input movement between at least four discrete points arranged in two dimensions and providing a series of discrete input. An electronic display (13) is provided for displaying a first subset of two-dimensional information, while a memory (15) is provided for storing a larger second two-dimensional information set. The memory (15) has storage capacity for the second two-dimensional information of a size greater than the first two-dimensional information capable of being displayed on the electronic display (13). Accordingly, a processor (11) coupled with the array of switching elements (20) is provided for information processing such that the display (13) and the memory (15) are selectable by the processor program (14) for correlating the first two-dimensional information with a series of discrete inputs received from the array of switching elements (20). The display (13) of the first two-dimensional information is provided as representative of information taken from the second two-dimensional information stored in the processor memory (15).

### FIELD OF THE INVENTION

This invention relates to a method which permits a user to input data and to navigate relatively large text or graphic information such as data tables with a relatively small display unit using a compact input device in a novel and convenient manner useful for navigating big charts on hand-held devices such as mobile phones with miniature display screen, reduced keypad, and small form-factor.

### BACKGROUND OF THE INVENTION

Presently, there are at least two types of existing solutions for two-dimensional data or chart navigation on a reduced size display screen, i.e., navigation bar and navigation tree. The first type of existing solution, navigation bar, commonly seen in PC desktop environments, is to provide one horizontal navigation bar at the bottom and one vertical navigation bar on the right that facilitate left-right and up-down navigation. This design works fairly well in PC desktop environments with a relatively large screen, however the approach is almost unsuitable in miniature display screen mobile phone environments. Without header information, the context is lost making data reference incomprehensible and thus the data shown is hardly understandable. Moreover, the navigation bar approach does not support diagonal, i.e., simultaneous horizontal and vertical movements, and thus navigation within the data is fairly inefficient.

The second approach, the navigation tree, is commonly employed in mobile phones and digital personal organizers with small screens, which pre-converts a two- (and more generally multi-) dimensional data structure chart into tree-like multi-layer one-dimension lists and to navigate lists one at a time. For the example, a date column may be defined as the first layer and navigated with up/down navigation buttons. When the desired date is in focus, pressing a confirm (select or OK) key or moving cursor to the right will bring up as the second list another level of data associated with, e.g., that specific date. The same cursor-up/down keys can then be employed for navigating the new list.

For example, Starfish™ devices provide five keys, i.e., home, view, select, up and down arrows, that are used to select and view information. The user can hold down the “home” key to return to the Home screen from other screens. The View key changes the view within a main function. For example, in the Calendar, it cycles through the Daily, Weekly, and Monthly views. In the Contacts, it cycles through multiple cardfiles. In the To Do List, it cycles thrugh your Calls, Tasks, etc. The Select key selects an item or changes a setting. In the Monthly Calendar view, the device starts a highlight to select a date. The Up and Down keys scroll or move the highlight or setting up, down, left, or right, e.g., they move the highlight left or right on the Home screen so that you can select a main function. In the To Do List, they scroll the highlight up or down.

Navigation tree has better tractability than navigation bar for hand-held devices, as it forces user to explicitly pick the context as entry point. However, it does not provide much flexibility because it pre-defines the single navigation path and thus does not allow any way to navigate other than the pre-defined paths. For instance, the above data arrangement does not allow for navigating from a particular column down to a specific entry. Such arrangements make it very hard to compare data, e.g., from adjacent dates. As to navigation efficiency, navigation tree has not much difference from navigation bar as both are one dimensional.

There is a need therefore for an improved method for data entry navigation where fewer keys are needed, and where there is an intuitive relationship between the writing and the key pressing process, so as to achieve better ergonomic efficiency.

### BRIEF DESCRIPTION OF THE DRAWINGS

FIG. 1 is a block diagram illustrating an embodiment of a data entry device in accordance with the invention.

FIGS. 2a-2d are diagrams showing different examples of stroke or data sweep inputs using a four-switch input device.

FIG. 3 is a flow diagram illustrating operation of the program controlling the microprocessor of FIG. 1.

FIGS. 4, 5 and 6 are a front view, rear view and elevation view respectively of a joystick-type device for use in place of the input device of FIG. 1.

FIGS. 7a-7b represent an embodiment showing the directional logic provided with an input device in accordance with the invention.

FIG. 8 is a block diagram of an alternative embodiment of the invention.

FIGS. 9a-9f illustrate a chart and chart navigation in accordance with the invention.

### DETAILED DESCRIPTION OF THE PREFERRED EMBODIMENTS

According to one aspect of the present invention, a data entry device is provided comprising an array of switching elements capable of recording input movement between at least four discrete points arranged in two dimensions and providing a series of discrete inputs. The array of switching elements may be touch-sensitive or proximity-sensitive switches or pushbuttons and may be activated with a pen, finger or stylus, or they may be discrete points of operation of a joystick, trackball, mouse or similar device. They may be arranged at points of a compass or in a two-dimensional matrix array.

Briefly summarized, the present invention relates to a data navigation apparatus and method employing a compact input device. The apparatus includes an array of switching elements capable of recording input movement between at least four discrete points arranged in two dimensions and providing a series of discrete input. An electronic display is provided for displaying a first subset of two-dimensional information, while a memory is provided for storing a larger second two-dimensional information set. The memory has storage capacity for the second two-dimensional information of a size greater than the first two-dimensional information capable of being displayed on the electronic display. Accordingly, a processor coupled with the array of switching elements is provided for information processing such that the display and the memory are selectable by the processor program for correlating the first two-dimensional information with a series of discrete inputs received from the array of switching elements. The display of the first two-dimensional information is provided as representative of information taken from the second two-dimensional information stored in the processor memory.

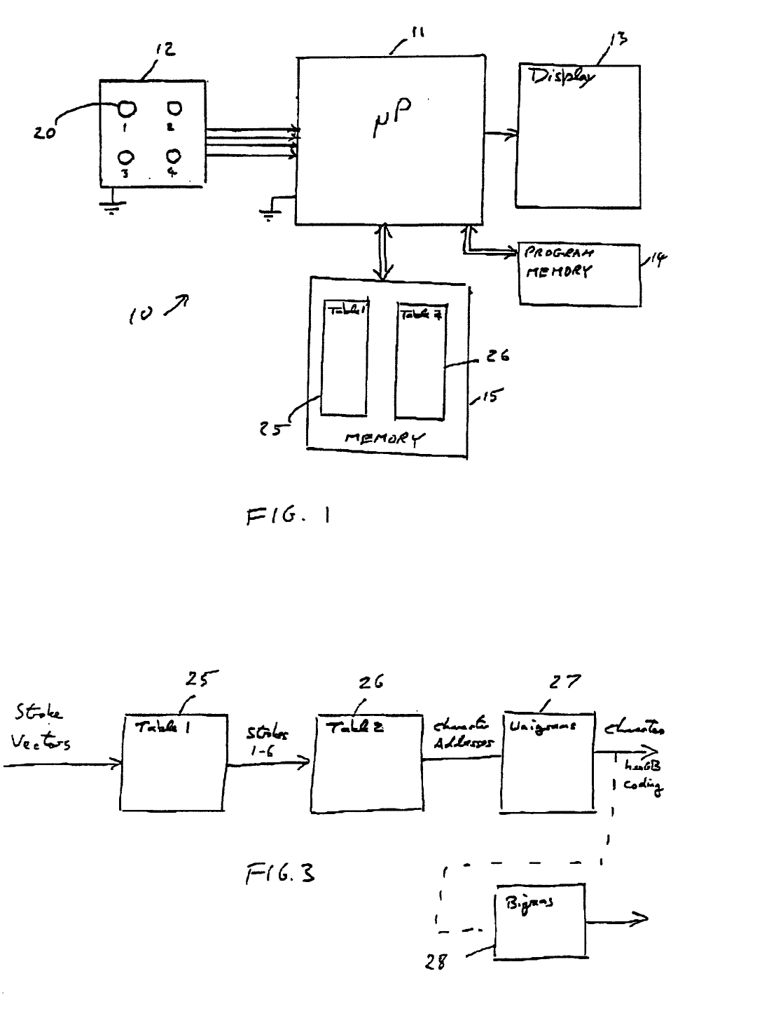

Referring to FIG. 1, a data entry device 10 such as a cellular telephone or a wireless messaging communicator, a digital personal organizer or the like, is shown comprising a microprocessor 11, an input device 12, a display 13, and may employ other devices such as a RF or IR link, a program memory 14 and a data memory 15.

The input device may take a number of forms, any of which is capable of recording input movement between at least four discrete points arranged in two dimensions. In one embodiment the input device has four push keys 20 in a matrix or square of about 1.5 cm in height and 1.5 cm width, with one key at each corner. For convenience, the top-left key is numbered 1, the top-right 2, the bottom-left 3, and the bottom-right 4. Each key can be sensitive to pressure or sensitive to merely the presence of the fingertip on or near the key. The four keys provide four inputs into the microprocessor. The four inputs are illustrated as four discrete lines, but it will be understood that four data states can be represented by two data lines (with or without a “data active” line).

The data entry device 10 may have further buttons (not shown) for other functions. For example, it preferably has a 12-key keypad for entry of digits 0-9 and for calling. Scrolling keys may be provided for menu control.

The memory 15 is illustrated as having two tables 25 and 26. Tables are not essential, but it will be explained below that tables are a useful and convenient manner of translating inputs from the input device 12 into primitive handwriting elements and the like for translating primitive handwriting elements into data characters. The memory 15 may also store data structures such as a chart which may be navigated using the data entry device 10 in the preferred embodiment.

In operation, a user enters vector or movement strokes into the input device 12 by passing his or her finger across the keys 20 in two dimensions in a horizontal plane. The input device 12 generates a series or sequence of discrete inputs to the microprocessor 11, dependent on the keys activated. The microprocessor, under the control of program code stored in program memory 14, performs a look-up or search operation in the memory 15 to identify the data cell locations in the data structure chart being navigated by the user, as discussed further below.

The data cells identified by the microprocessor 11 are displayed on display 13. Where several cells are identified, several data entries are displayed on display 13.

In operation, an apparatus is described for inputting stroke input. If a user wishes to input a left-right horizontal stroke, the user moves his or her thumb horizontally across key1 and key2. The signal that key1 and key2 have been consecutively visited in a particular sequence is sent to the microprocessor 11 for interpretation as horizontal stroke. In the same manner, for a top-down vertical stroke, the user moves his or her thumb across key1 and key2.

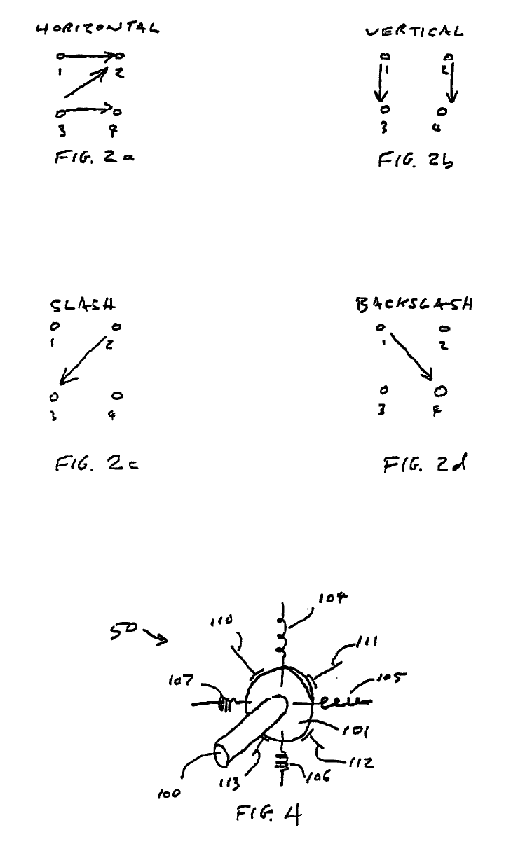

The method presented here defines multiple, e.g., six fundamental strokes or sweeps of data selection for navigation, e.g., “horizontal”, “vertical”, “slash”, and “back slash”. There now follows, with reference to FIGS. 2a-2d, a brief description of the fundamental strokes or data sweeps and how they can be entered via sequence of keys. A thumb move path is the sequence of keys which have been visited during a preset time period from the first key of the sequence being visited until a pre-defined time-off is detected. A time-off is the time elapse from the moment the previous key is visited to the moment the next key is visited.

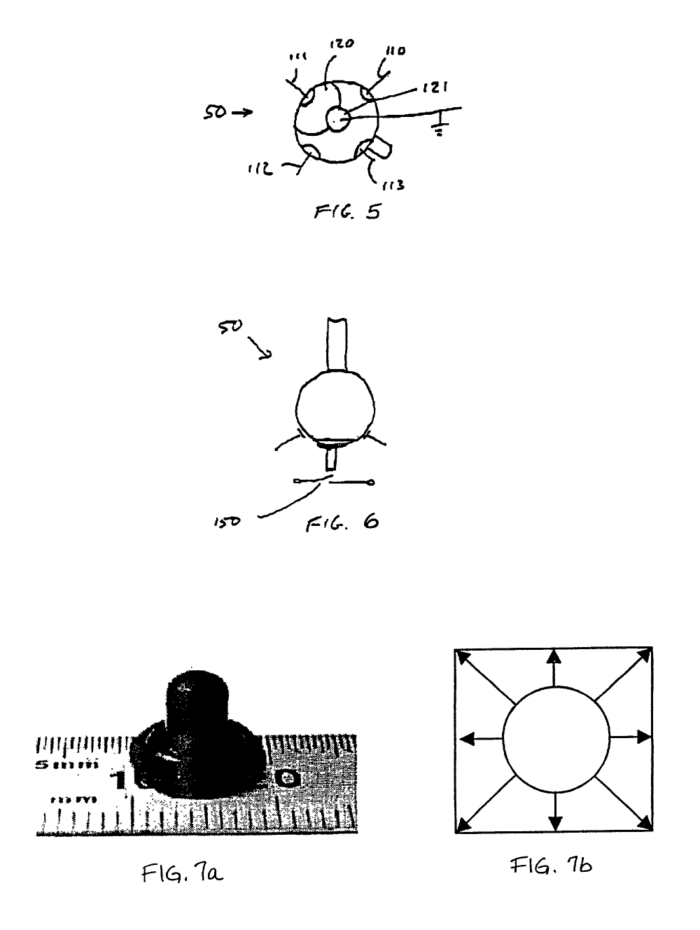

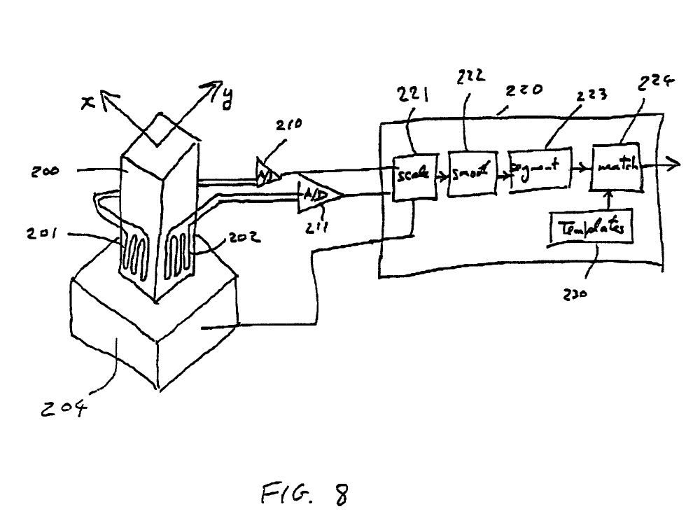

Upon entering strokes or data sweeps using discrete thumb, finger, stylus, trackball, mouse or other two-dimensional stroke inputs, i.e. discrete signals representative of discrete vectors, the microprocessor 11 does a look-up or other search in table 26 in memory 15. A two-stage translation reduces the size of table 26. As illustrated in FIG. 3 herein, a further table 27 may be used for character input as well as data navigation sweep inputs for characters located at addresses corresponding to character addresses from table 26. A character may thus be read from table 27 located at a character address obtained from table 26. A further table 28 can optionally be provided to perform look-up operations. The output of table 27 (or table 28 if used) is standard hexGB coding of one or more characters. A further look-up is used to obtain and display the pictorial representations.

The above method has some notable and advantageous features, e.g., making use of only four keys, the keypad can be relatively small in size. The four keys are distinctively positioned, the chance of getting confused with different keys and thus resulting misfires on wrong keys has been greatly reduced. It associates the thumb move path over the keys with the actual trajectory of the intended stroke or sweep. This builds an intuitive relationship between the data navigation and key pressing processes. It allows a user to input strokes or sweeps of data in a chart in a natural and convenient manner.

Referring to FIGS. 4, 5 and 6, hardware variations are illustrated in which a front view, rear view and elevation view respectively of an alternative input device 50 are shown. The alternative input device has a joystick element 100 (which term is to be understood as including other button or lever devices moveable in two dimensions in a horizontal plane, including mouse-buttons). The joystick element 100 is mounted on a spring-loaded mounting illustrated as a ball-and-socket mounting 101 by way of example. The mounting is biased such that the joystick element returns to a central resting position (not shown) when not under thumb or finger pressure. Springs 104-107 are shown as providing bias, but it will be understood that these need not be discrete helical springs and may be replaced by a single elastomeric member. Four discrete contacts 110-113 are shown at four equally spaced compass points around the center (north-west, north-east, south-east and south-west respectively).

As shown in FIG. 6, there is a silvered circle 120 on the rear of the ball of the ball-and-socket mounting 101 and there is a ground contact 121 fixed relative to the ball-and socket mounting and positioned centrally behind the ball.

In operation, a user moves the joystick element 100 with his or her thumb or finger and the ball rotates such that the silvered circle 120 makes contact between the ground contact 121 and one of the discrete compass-point contacts 110-113. In this way, the input device of FIG. 5 can generate a series of discrete inputs just like the four-key input device 12 of FIG. 1. A north-west movement of the joystick generates the same input as key 1 of input device 12, and so on.

It will be understood by one of ordinary skill in the act that other joystick elements can achieve the same result. For example, a ball-and-socket arrangement with an asymmetric ball can be used that activates four or more microswitches similar to the buttons of input device 12 of FIG. 1. The joystick does not need to have a ball-and-socket at all.

It will also be understood by one of ordinary skill in the art that more than four contacts can be used for the input device 12 of FIG. 1 or the input device 50 of FIG. 5. For example, six, eight, twelve or sixteen compass point contacts can be used. Alternatively, a matrix of 3×3 or 4×4 buttons or contacts could be used. Tables 1 and 2 would need to be reformulated accordingly, and there would be many more stroke variations permissible for each item in these tables. Alternatively, the joystick button input device of FIG. 5 does not have a ball-and-socket, but is fixed on its mounting and uses orthogonal strain gauge elements to provide a continuous (i.e. progressive, non-discrete) 2-dimensional output (e.g. two analog voltage outputs) which is divided into discrete values by the microprocessor 11 or by an interface into the microprocessor 11 (e.g. an analog-to-digital converter).

Referring to FIG. 7, a microswitch 150 is shown mounted beneath the ball-and-socket mounting 101 of the input device 50 of FIG. 5. The microswitch 150 is a push-to-make switch and can be used for a number of purposes. Accordingly, the switching elements discussed herein provide for an apparatus including an array of switching elements capable of recording input movement between at least four discrete points arranged in two dimensions and providing a series of discrete input. An electronic display is provided for displaying a first subset of two-dimensional information, while a memory is provided for storing a larger second two-dimensional information set. The memory has storage capacity for the second two-dimensional information of a size greater than the first two-dimensional information capable of being displayed on the electronic display. Accordingly, a processor coupled with the array of switching elements is provided for information processing such that the display and the memory are selectable by the processor program for correlating the first two-dimensional information with a series of discrete inputs received from the array of switching elements. The display of the first two-dimensional information is provided as representative of information taken from the second two-dimensional information stored in the processor memory.

In one embodiment, the microswitch 150 is used as a pen-down indicator. In this variation, a single input stroke is measured from pen-down to pen-up. This has the advantage of disambiguating between pen-down and pen-up segments. All contiguous pen-down segments can be captured and used for character recognition, regardless of whether they are captured within a time-out time or after expiry of a time-out timer. This allows for greater flexibility in user-variations of time duration when entering strokes or characters. A “data active” line on the input device 12 of FIG. 1 can perform the same function, such that all continuous thumb-down movements cause an activation of at least one button and cause activation of the “data active” line, whereas a thumb-up event gives no data active signal. Instead of a data active line, timing measurements by the processor 11 can be used to measure the time lapse between button presses (if any) and so determine if there has been a thumb-up event.

In FIG. 8, a joystick element 200 is shown having strain gauges (or other analog elements) 201 and 202 that provide analog movement indications for movement of the joystick element 200 in orthogonal x and y dimensions in a horizontal plane. Integral with the joystick element 200 is a push switch 204, preferably a push-to-make switch.

The analog elements 201 and 202 are connected to analog-to-digital (A/D) converters 210 and 211 (or to a single shared A/D converter), which are coupled to a processor 220. The switch 204 is also coupled to the processor 220.

The processor 220 has a program stored in program memory that causes it to perform a scaling (normalizing) function 221 on the inputs from the A/D converters 210 and 211. Inputs from the A/D converters are accepted by the scaling function 221 when the switch 204 indicates a “push” condition (equivalent to a pen-down state). Following the scaling function, an optional smoothing function 222 is carried out and a segmentation function 223. The segmentation function segments the two-dimensional input into segments at natural bends in the input, thereby providing a sequence of raw stroke segments. A matching function 224 matches the segments against pre-stored templates from template store 230 in a manner known in the art.

The arrangement of FIG. 8 is particularly useful for entry and recognition of ideographic characters (e.g. Chinese characters), but is not limited thereto, and is useful for Roman character entry or Graffiti (trade mark) type of stroke entry. The smoothing, segmenting and matching steps can be modified (or omitted where unnecessary) to suit the type of data entry.

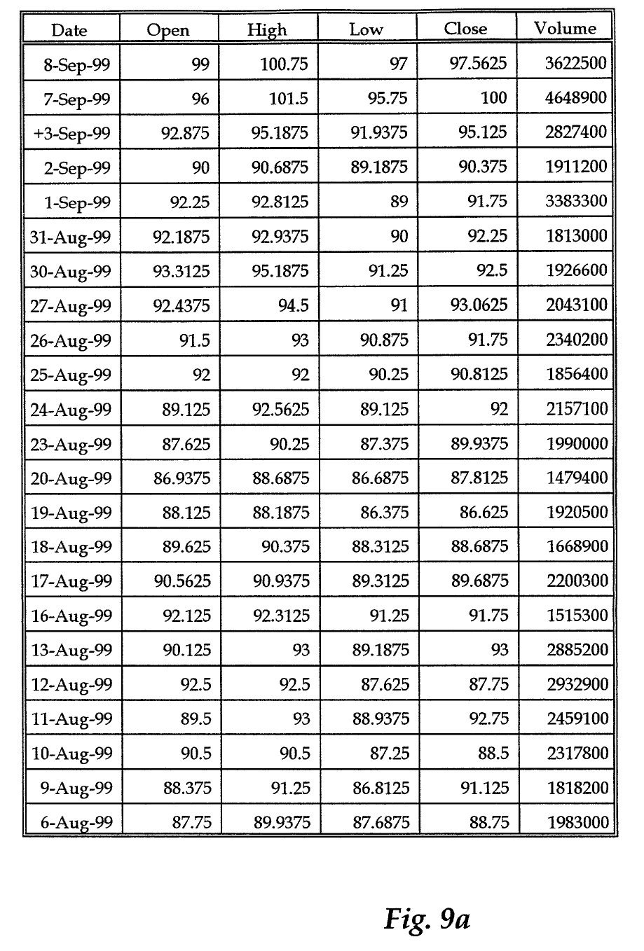

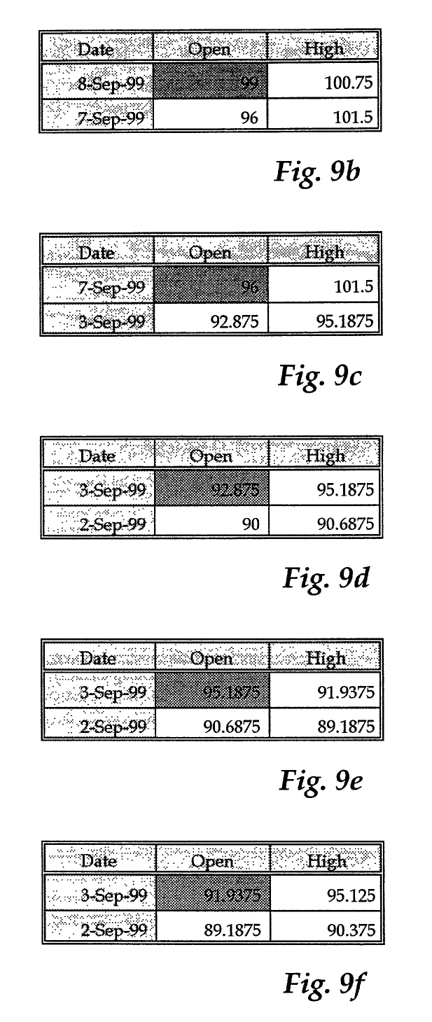

The navigation array as discussed herein provides an improvement and replacement of the prior art. Firstly, for improving tractability and thus enhancing navigation effectiveness, both top and left headers are kept on display all the time. FIGS. 9a-9f illustrate the task of browsing and navigating a big two-dimensional chart similar to what is shown in FIG. 9a on a mobile phone with small screen, and shows five subsequent small screen shots evolving from the origin (upper left corner) to two rows downwards plus two columns to the right. Secondly, for improving navigability and thus enhancing navigation efficiency, both diagonal cursor navigation movements are supported. By that, there are only two steps southeast from upper-left corner to two-row-two column down. You can further experience smooth and continuous navigation by pressing and manipulating the switch of FIG. 7a, or in a way similar to using mouse or track ball. Morever, a (double) click will trigger any pre-defined action associated with the cell in focus (the cell in highlighted cells in FIG. 9).

There are many possible variations and improvements to the above basic design. Some of them are listed below and many others can be derived naturally by analogy. The above design works fine (without diagonal navigation) with existing four-way navigation button. Applicant's assignee's commercial device, WisdomTouch™ can easily and naturally be emulated by normal phone digital keypad. For example, key-1 can be naturally assigned for upper-left movement and key-9 for lower-right movement.

TABLE I

| | | |
|---|---|---|
| 1 UpperLeft | 2 Up | 3 UpperRight |
| 4 Left | 4 (Double) Click | 6 Right |
| 7 LowerLeft | 8 Down | 9 LowerRight |

The phone digital keypad can also be used for one-touch chart positioning. It is pretty intrinsic to press key-9 for positioning the focus of a phone window to the lower-right corner of a big chart. Table II gives a complete assignment.

TABLE II

| | | |
|---|---|---|
| 1 UpperLeft | 2 UpperMiddle | 3 UpperRight |
| 4 MiddleLeft | 4 Central | 6 MiddleRight |
| 7 LowerLeft | 8 LowerMiddle | 9 LowerRight |

Note, keypad emulation and one-touch positioning can perfectly co-exist with each other through assigning normal key press to one function and press-hold action (press a key for a short while until the function gets triggered) to another.

Keypad emulation and one-touch positioning can be realized much more user friendly with StarPad/EasyKey, which is basically a keypad hardware alternative with (limited) software configurable keypad layout that allows progressive and/or context sensitive disclosure interface and recycles keypad real estate. Put it simple, StarPad/EasyKey makes WisdomTouch available on small phones without hardware navigation button. Key-0 can be applied to toggle on and off top and left headers. Key-* can be applied to transpose the column in focus one position left. Key-# can be applied to transpose the row in focus one position up.

TABLE III

| | | |
|---|---|---|
| 1 UpperLeft | 2 Up | 3 UpperRight |
| 4 Left | 4 (Double) Click | 6 Right |
| 7 LowerLeft | 8 Down | 9 LowerRight |
| * ColumnLeft | 0 ToggleHeaders | # RowUp |

Toggling headers off will temporarily make more space available for showing data. It is especially useful for comparing data in adjacent cells. Allowing column and row transposition make it possible to rearrange any chart in any order. It is especially helpful for comparing any two lines of data by putting them side by side. Note, from functionality perspective, key-* and key-# jointly are complete.

While the foregoing described embodiments have been set forth above, it will be appreciated to one skilled in the art that the inventions described have applications beyond the described embodiments. Accordingly, it is intended that the scope of the invention including such alternatives, modifications, and variations contemplated shall be defined by the appended claims.

What is claimed is:

1. A data navigation method using a compact input device, comprising:
providing an array of switching elements capable of recording movement between at least four discrete points arranged in two dimensions and providing a series of discrete input;
displaying first two-dimensional information;
storing second two-dimensional information in a memory having storage capacity for the second two-dimensional information of a size larger than the first two-dimensional information capable of being displayed on said display; and
coupling the provided array of switching elements with an information processor programmed for selecting the first two-dimensional information with a series of discrete inputs received from the array of switching elements for displaying the first two-dimensional information representative of information taken from the second two-dimensional information from the storing step.

2. A navigation method as recited in claim 1, wherein the stored second two-dimensional information includes a two-dimensional chart having data cells of a number substantially greater than the number of cells displayed by the first two-dimensional information displayed by said displaying step.

3. A method as recited in claim 1, wherein the step of providing switching elements provides an array of finger, operated switches.

4. A method as recited in claim 3, wherein the finger operated switches provided are operable with a multi-dimensional input device selecting multiple sectors for navigation of the second two-dimensional information stored by said storing step.

5. A method as recited in claim 4, wherein said displaying step further comprises displaying descriptive information along the axes of a display area for correlating the first two-dimensional information with the second two-dimensional information stored by said storing step.

6. A data navigation apparatus using a compact input device, comprising:
an array of switching elements capable of recording input movement between at least four discrete points arranged in two dimensions and providing a series of discrete input;
a display for displaying first two-dimensional information;
a memory having stored therein second two-dimensional information, said memory having storage capacity for the second two-dimensional information of a size larger than the first two-dimensional information capable of being displayed on said display; and
a processor coupled to said array of switching elements, said display and said memory being programmed for selecting the first two-dimensional information with a series of discrete inputs received from said array of switching elements for displaying the first two-dimensional information representative of information taken from the second two-dimensional information stored in said memory.

7. A navigation apparatus as recited in claim 6, wherein the second two-dimensional information stored in said memory comprises a two-dimensional chart having data cells of a number substantially greater than the number of cells displayed by the first two-dimensional information displayed on said display.

8. An apparatus as recited in claim 6, wherein said array is an array of finger-operated switches.

9. An apparatus as recited in claim 8, wherein said array of finger-operated switches are operable with a multi-dimensional input device for selecting multiple sectors for navigation of the second two-dimensional information stored in said memory.

10. An apparatus as recited in claim 6, wherein said array comprises a joystick element.

11. An apparatus as recited in claim 10, wherein said joystick element comprises a pushbutton switch.

12. An apparatus as recited in claim 6, wherein said display for displaying said first two-dimensional information, comprises descriptive information along the axes of said display area correlating said first two-dimensional information with said second two-dimensional information stored in said memory.

13. A data navigation apparatus including a compact input device, comprising:
means for switching an array of finger operable switching elements capable of recording input movement between at least four discrete points arranged in two dimensions and providing a series of discrete input;
means for displaying first two-dimensional information;
means for storing second two-dimensional information, said storing step having storage capacity for the second two-dimensional information of a size larger than the first two-dimensional information capable of being displayed by said means for displaying; and
means for information processing coupled with said means for switching for selecting the first two-dimensional information with a series of discrete inputs from the finger operable switching means for displaying the first two-dimensional information representative of information taken from the second two-dimensional information from said means for storing.

14. A data navigation apparatus as recited in claim 13, wherein said means for storing the second two-dimensional information comprises a two-dimensional chart having data cells of a number substantially greater than the number of cells being displayed as the first two-dimensional information with said means for displaying.

15. A data navigation apparatus as recited in claim 14, wherein said means for displaying comprises means for displaying descriptive information along the axes of a display area for providing information correlating the first two-dimensional information with the second two-dimensional information stored by said means for storing.
